(19) United States
(12) Patent Application Publication
(10) Pub. No.: US 2012/0117373 A1
(43) Pub. Date: May 10, 2012

(54) METHOD FOR CONTROLLING A SECOND MODALITY BASED ON A FIRST MODALITY

(75) Inventors: Dzmitry V. Aliakseyeu, Eindhoven (BY); Tsvetomira Tsoneva, Eindhoven (BG); Janto Skowronek, Eindhoven (NL); Pedro Fonseca, Antwerpen (PT)

(73) Assignee: Koninklijke Philips Electronics N.V., Eindhoven (NL)

(21) Appl. No.: 13/383,677

(22) PCT Filed: Jul. 6, 2010
(86) PCT No.: PCT/IB2010/053095

§ 371 Date: Jan. 12, 2012

(30) Foreign Application Priority Data
Jul. 15, 2009 (EP) 09165492.1

(51) Int. Cl. G06F 9/06

(52) U.S. Cl. 713/100

(57) ABSTRACT

A method for controlling a second modality based on a first modality is provided. The method comprises the steps: providing a first modality comprising time-dependent characteristics and a second modality capable of changing its appearance over time; automatically determining changes in the appearance of the second modality based on the time-dependent characteristics of the first modality; adjusting a smoothing degree by means of a user input device; and adapting the determined changes in appearance of the second modality based on the smoothing degree and on boundaries present in the time-dependent characteristics of the first modality to arrive at resulting changes in the appearance of the second modality.

### FIELD OF INVENTION

The present invention relates to controlling a second modality based on a first modality.

### BACKGROUND OF THE INVENTION

In the context of the present application, the term modality is used to describe information comprising time-dependent characteristics, i.e. being capable of changing its appearance over time, and being perceivable by human beings with their senses. In particular, a modality can be formed by visual, audible, audio-visual, or tactile information which comprises time-dependent characteristics. For example, a modality can be formed by a sound signal which is changing over time such as music, by a video signal, or by a light signal changing over time such as lighting of different colors or other light effects. Further examples for a modality are for example breeze (or wind) effects and vibration or rumble effects or other tactile information and respective control signals for such effects. The term appearance is used to describe how the modality appears to a human perceiving the information. For example, with respect to sound, the appearance can be a certain volume, a certain frequency, tone or tune, or combination of frequencies or tones, and the like. For example, with respect to light, the appearance can be a certain light signal such as light of a specific color or combination of colors, or a specific light effect or combination of light effects, or a specific lighting of a room, e.g. in a specific color or combination of colors, or with different light sources, and the like. For example, with respect to tactile information, the appearance can be certain intensity of breeze or wind effects, an intensity of vibration or rumble effects, and the like. A change in appearance means a change from one well-defined appearance to another distinguishable well-defined appearance such as e.g. a change in color of lighting or a change in tone, a change in intensity, and the like.

Color-music perception studies have led to the result that colored light significantly enriches the experience of listening to music. In consequence, technical means that combine music with lighting effects can enrich the experience of listening to music. However, an important aspect in this respect is that a balance between automatic combination of music and lighting effects and the possibility of user intervention and/or user control is desirable. Users in color-music perception studies stated that, on the one hand, they want to have control over the system and, on the other hand, do not want to have to use a control device all the time.

As a consequence, there is a need for solutions which provide an automatic mode not requiring user intervention and which in addition provide the possibility of user intervention. With respect to the combination of music and light, one possible automatic mode could assign colored light to music, e.g. by estimating the mood conveyed by the music and choosing a color that people associate with that mood. Light of the thus determined color would then accordingly be displayed during music playback.

One possibility of assigning color to music according to such a scheme is e.g. disclosed by Gavin Wood and Simon O'Keefe in “On Techniques for Content-Based Visual Annotation to Aid Intra-Track Music Navigation” from 2005 which is available at http://ismir2005.ismir.net/proceedings/1023.pdf. Although this publication relates to intra-track music navigation, the colors assigned to music tracks according to the described scheme could also be used as lighting colors to be displayed during music playback. Further, this publication shows displaying the occurring colors over time (i.e. as function in the position in a music track) in a so-called “mood bar”.

However, as has been mentioned above, with respect to assigning lighting to music users prefer to have some control over the result. Further, a user typically wants to have the possibility to control without the need for a detailed programming activity. In particular, a user does not want to have to edit individual color changes with respect to every new music playlist which is prepared (e.g. on a computer). As a consequence, a control device with which a user can influence the lighting effects which occur in combination with music should be compact and easy to handle and should not require a sophisticated learning process for the user to become familiar with the control device. Further, there is a user demand that the combination of music and light should be predictable.

Similar problems occur with respect other methods and systems in which a second modality is controlled based on a first modality, such as changing between different dynamic light effects to enrich the experience of one modality by adding another one, e.g. by adding light effects to movies, or by adding sound effects to light atmosphere or other visual effects.

### SUMMARY OF THE INVENTION

It is an object of the present invention to provide a method and a device for controlling a second modality based on a first modality such that changes in the appearance of the second modality are (pre-)determined in an automatic manner to some extent while user control of the changes in the appearance of the second modality is possible in a controllable and predictable manner which conveniently maintains a certain degree of control of the second modality based on the first modality.

This object is solved by a method for controlling a second modality based on a first modality according to claim 1. The method comprises the steps: providing a first modality comprising time-dependent characteristics and a second modality capable of changing its appearance over time; automatically determining changes in appearance of the second modality based on the time-dependent characteristics of the first modality; adjusting a smoothing degree by means of a user input device; and adapting the determined changes in appearance of the second modality based on the smoothing degree and on boundaries present in the time-dependent characteristics of the first modality to arrive at resulting changes in the appearance of the second modality. Thus, according to the invention a smoothing degree is adjusted by means of a user input device. The smoothing degree can for example be set as a certain value within a range of values, e.g. as a value between 0 and 1 or as a value within another range. The input device can be formed by any suitable input device enabling inputting of such a value. The input device can e.g. preferably (for reasons of user convenience) be formed by a single input device by which only one value can be adjusted such as an adjusting knob or adjusting slider. Such an input device can e.g. be realized in hardware by means of a physical object or in software as a virtual object, e.g. as a visual representation of an adjusting knob or adjusting slider or as a scroll bar. The changes in the appearance of the second modality which have been determined are adapted based on the smoothing degree and also based on boundaries which are present in the time-dependent characteristics of the first modality. Thus, adaptation of the changes in the appearance of the second modality takes into account both the user input and the boundaries of the first modality. In this way, the user is allowed to influence the resulting changes in the appearance of the second modality (e.g. can to some extent personalize, slightly adjust, or overrule the automatic determination). On the other hand, since the boundaries in the first modality are exploited, the resulting changes in the appearance of the second modality do not lose a certain degree of coherence to the time-dependent characteristics of the first modality. The boundaries in the first modality which are exploited can in the case of music being the first modality e.g. be formed by changes in volume, changes in rhythm magnitude, changes in magnitude between different bands of wavelengths, and so on. For example, the same boundaries which are used for automatic determination of changes in the appearance of the second modality can be used. For example, these boundaries corresponding to the initial automatically determined changes in the appearance of the second modality can be assigned with an importance value determining at which smoothing degree the corresponding change in the appearance of the second modality is to be deleted or restored, respectively. With respect to e.g. light signals as a first modality, changes in color, brightness, spectral content and the like can form the boundaries to be exploited. Similarly, with respect to a video signal as a first modality, major changes between frames and the like can form the boundaries.

Preferably, the first modality is any one of a sound signal, a video signal, and a light signal. Preferably, the second modality is any one of a light signal, a sound signal, and a video signal. In particular, the combination of a sound signal such as music with a video or light signal, the combination of a video signal with a light signal or sound signal, and the combination of a light signal with a video signal or sound signal are particularly relevant fields for which content enrichment is of interest. The sound signal can for example be the sound itself or more preferred a representation thereof such as an analog or digital representation thereof (e.g. an MP3-file or the like). Similarly, the video signal can e.g. be the visual signal or an analog or digital representation thereof. Similarly, the light signal can e.g. be a visual light signal or an analog or digital representation thereof such as a control signal for the light and the like. The light signal can e.g. be realized by a single light source (possibly capable of emitting light of different colors) or by a combination of light sources. The light signal can e.g. be realized as lighting of a room or other location.

According to a preferred realization, the first modality is a sound signal and the second modality is a light signal, in particular a light signal of variable color. The sound signal can for example be a signal representing music and the light signal the lighting of a room or other location. In particular, the content enrichment of music as a first modality with light of variable color as a second modality has proved to enrich the experience of listening to music. Preferably, the second modality is formed by lighting effects. These lighting effects can e.g. be formed by specific lighting sceneries, different types of light sources, different colors of light, etc. Lighting of a room or other location in different colors is of particular relevance.

Preferably, the method further comprises the step: providing a visual preview representation of the resulting changes in appearance of the second modality. In this case, a user is provided with a visual feedback with regard to the adaptation of the changes in the appearance of the second modality. Thus, the user can easily adjust the smoothing factor to arrive at the desired result. The visual preview representation of the resulting changes can e.g. be provided in form of a mood bar representing the changes in the appearance of the second modality as a function of time. For music as a first modality and colored lighting as a second modality, the visual preview representation can e.g. be provided in form of a mood bar as disclosed by Gavin Wood and Simon O'Keefe in the reference mentioned above. However, it should be noted that other visual representations are possible as well. The visual preview representation can e.g. be provided on a screen or other suitable display.

Preferably, discrete changes in the appearance of the second modality are deleted or restored dependent on the smoothing degree. In this case, the user can easily reduce and enhance the number of changes in the appearance of the second modality by simply adjusting the smoothing degree. This can be realized very convenient with a single user input device adapted for changing only one value. Preferably, with increasing smoothing degree the number of resulting changes in appearance of the second modality is lowered. For example, the smoothing degree can be translated into a fixed number of changes which are allowed within a defined period of time.

According to one aspect, with increasing smoothing degree, shorter blocks in time in the determined changes in appearance of the second modality are increasingly replaced by adjacent blocks of appearance present in the determined changes in appearance of the second modality. In this case, a convenient way of reducing changes in the appearance of the second modality is provided which maintains the correlation between the time-dependent characteristics of the first modality and the changes in the appearance of the second modality. This case can e.g. be realized by deleting or restoring blocks of changes in the appearance of the second modality dependent on the smoothing degree by merging or separating the respective blocks. In this context, merging means that the block merged to another block is provided with the same appearance as the other block, while separating means that the block is provided with its original appearance.

According to one aspect, with increasing smoothing degree, determined changes in the appearance of the second modality corresponding to changes in the time-dependent characteristics of the first modality are increasingly deleted dependent on the amount of change present in the time-dependent characteristics of the first modality. For example, the determined changes in the appearance of the second modality can be provided with an “importance value” indicating at which smoothing degree the respective change is to be deleted. With respect to music being the first modality, this can e.g. be realized by assigning to a change in the appearance of the second modality (such as a color change in lighting) corresponding to a change in the music a high importance value when the music changes a lot, while assigning to a change in the appearance of the second modality a low importance value when the music changes to a lesser degree.

Preferably, the automatically determined changes in the appearance of the second modality are assigned with a value reflecting at which smoothing degree the change is to be deleted and restored, respectively. In this case, the automatically determined changes are already provided with an “importance value” resulting in that, upon adjusting the smoothing degree by user input, still the changes in the appearance of the second modality correlate very well with the time-dependent characteristics of the first modality. Such an importance value can e.g. be defined based on the duration between subsequent determined changes in the appearance of the second modality or based on the amount of changes in the time-dependent characteristics of the first modality.

According to one aspect, with increasing smoothing degree, the minimum time interval between subsequent changes in the resulting changes in the appearance of the second modality is prolonged. In this way, rapid changes in the appearance of the second modality can be suppressed by a user by adjusting the smoothing degree to a higher value. Thus, increasing the smoothing degree conveniently results in smoothing the behavior of the second modality in a manner which is predictable and comprehensive for the user. At the same time, the mapping of the behavior of the second modality to the time-dependent characteristics of the first modality can be maintained.

The object is also solved by a device for controlling a second modality based on a first modality according to claim 13. The device comprises: an output outputting a control signal for controlling the appearance of a second modality based on a first modality comprising time-dependent characteristics, the second modality being capable of changing its appearance over time; and a user input device adapted for inputting a smoothing degree by a single adjuster. The device is adapted such that: changes in the appearance of the second modality are automatically determined based on the time-dependent characteristics of the first modality, and the automatically determined changes in the appearance of the second modality are adapted based on the smoothing degree and on boundaries present in the time-dependent characteristics of the first modality such that a signal corresponding to resulting changes in appearance of the second modality is output. The device achieves the same advantages as described above with respect to the method. Since the user input device is adapted for inputting a smoothing degree by a single adjuster, user control of the smoothing degree is enabled in a user-friendly and convenient manner. The single adjuster can e.g. be formed by an adjusting knob, an adjusting slider, a scroll bar, or the like. The adjuster can e.g. be realized in hardware or can be implemented as a virtual adjuster in software.

Preferably, the device comprises a visual user interface and is adapted such that a visual preview representation of the resulting changes in appearance of the second modality is provided on the visual user interface. In this case, a user is provided with a visual feedback with regard to the adaptation of the changes in the appearance of the second modality. Thus, the user can easily adjust the smoothing factor to arrive at the desired result. The visual preview representation of the resulting changes can e.g. be provided in form of a mood bar representing the changes in the appearance of the second modality as a function of time. For music as a first modality and colored lighting as a second modality, the visual preview representation can e.g. be provided in form of a mood bar in the way described above. However, it should be noted that other visual representations are possible as well. The visual preview representation can e.g. be provided on a screen or other suitable display as a visual user interface.

The object is also solved by a computer program product according to claim 15. The computer program product is adapted such that, when the instructions of the computer program product are executed on a computer, the following steps are performed: analyzing data corresponding to a first modality comprising time-dependent characteristics, outputting data corresponding to a control signal for a second modality capable of changing its appearance over time; automatically determining changes in appearance of the second modality based on the time-dependent characteristics of the first modality; adjusting a smoothing degree based on a user input via a single adjuster; and adapting the determined changes in appearance of the second modality based on the smoothing degree and on boundaries present in the time-dependent characteristics of the first modality to arrive at resulting changes in the appearance of the second modality. The computer program product achieves the advantages which have been described above with respect to the device for controlling a second modality based on a first modality. The computer program product may be provided in a memory in a computer, may be provided on any suitable carrier such as CD, DVD, USB-Stick and the like, or can be provided to be downloadable from a server via a network, e.g. via internet. Further, other ways of distributing the computer program product known in the art are possible.

### BRIEF DESCRIPTION OF THE DRAWINGS

Further features and advantages of the present invention will arise from the detailed description of embodiments with reference to the enclosed drawings.

FIG. 1 is a schematic representation for explaining an embodiment.

FIG. 2 is block diagram schematically showing the steps of a method for controlling a second modality based on a first modality.

FIG. 3 schematically shows an example of a visual preview representation of resulting changes in appearance of the second modality.

### DETAILED DESCRIPTION OF EMBODIMENTS

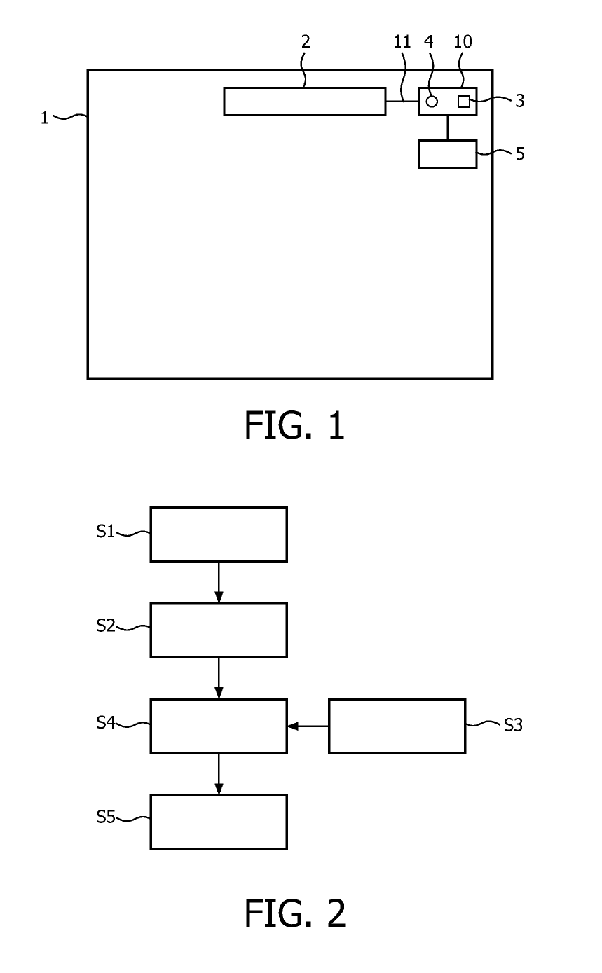

An embodiment of the present invention will now be described with reference to the Figures. In the embodiment which will be described in the following, the first modality is formed by music, more specifically by a data signal representing music. The music can e.g. be provided on a carrier in hardware, such as a CD or DVD or the like, or can be provided in form of an analog or digital data signal as is known in the art. Preferably, the music is provided in form of a digital data signal such as for example an MP3 file or the like. In the example shown in FIG. 1, the first modality 3 is provided in a device 10 for controlling a second modality based on a first modality. Such device can e.g. be formed by a computer, a PDA (personal digital assistant), a mobile phone, a mobile music player (such as an MP3 player), and the like. Alternatively, the first modality 3 can be provided to the device 10 from the outside via an input. In the embodiment, the second modality is formed by colored light which is used for lighting a location 1 which is schematically shown as a room in FIG. 1. The second modality (formed by the colored light) is emitted by a suitable light source 2 capable of emitting light of different colors. Although in FIG. 1 it is shown that the light source 2 is provided separate from the device 10 and connected thereto via a suitable connection line 11, the light source 2 may also be wirelessly connected to the device or may be integrated with the device 10 to an integrated unit. The device 10 is provided with a user input device 4 which is schematically indicated as a rotary adjusting knob in FIG. 1. It should be noted that, although a rotary adjusting knob realized in hardware in shown as the user input device, many other solutions for realizing user input with one single adjuster for adjusting one value are possible. For example, the user input device can also be realized in software and graphically represented on a screen such as in case of a scrollbar, a (virtual) slider adjuster, a (virtual) rotary knob, and the like. The user input device can thus be realized such that user input is achieved by moving a (hardware) adjuster or by adjusting a virtual adjuster e.g. with a mouse, key board, touch pad, touch screen, and the like. The user input device 4 in any case has a simple structure such that a value which will be called smoothing degree in the following can be conveniently input via a single adjuster.

According to the embodiment, the device 10 is further provided with a visual user interface 5 which is a display adapted for displaying information to a user in the example. The visual user interface 5 can e.g. be formed by a color screen such as e.g. provided in known mobile phones, PDAs, portable or stationary computers and the like. Although in FIG. 1 the visual user interface 5 is provided separate, linked either wireless or via cable to the device 10, the visual user interface 5 can also be provided integrated with the device 10 to a single unit. In the case of the user input device 4 being formed by a virtual adjuster realized in software, a graphical representation of the user input device 4 can e.g. be provided on the visual user interface 5.

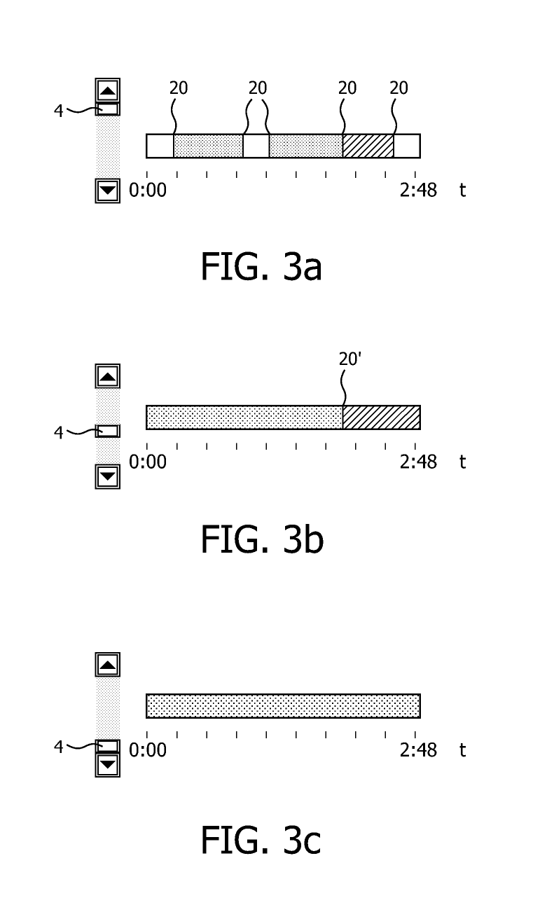

Operation of the device for controlling a second modality based on a first modality will be described in the following with reference to FIGS. 2 and 3.

In a first step S1, a first modality comprising time-dependent characteristics is provided. In the example, this is done by providing music data to the device 10.

In a step S2, based on the time-dependent characteristics of the first modality (e.g. the changes in music as a function of time in the example), the device 10 automatically determines changes in appearance of the second modality based on the time-dependent characteristics of the first modality. In the example which is described in detail, the second modality is formed by colored lighting effects generated by the light source 2. Thus, in the example, changes in color of the emitted light are automatically determined based on the time-dependent characteristics of the music. This can e.g. be achieved in a manner as disclosed for generating a “mood bar” by Gavin Wood and Simon O'Keefe in “On Techniques for Content-Based Visual Annotation to Aid Intra-Track Music Navigation” from 2005 which is available at http://ismir2005.ismir.net/proceedings/1023.pdf. According to the embodiment, the results of this determination are displayed on the visual user interface 5. One possible representation of this is shown in FIG. 3a. In the example given in FIG. 3a, the user input device 4 is realized as a scroll bar which is also displayed on the visual user interface 5. As can be seen in FIG. 3a, the changes 20 in the appearance of the second modality (which are changes in color of the light in the example) are displayed as a function of time t in the two-dimensional graphical representation in form of a color bar. It should be noted that this is a preferred and particularly convenient representation. However, other suitable graphical representations are also possible.

In a step S3, the smoothing degree is adjusted by means of the user input device 4. In the representation of FIG. 3a, the smoothing degree is set to a value corresponding to “no smoothing”. In the example shown, the smoothing degree is adjusted by changing the position of the scroll bar on the left in FIGS. 3a to 3c. This can be done in any convenient way known in the art. In the case of the user input device being formed by another single adjuster, the smoothing degree is adjusted by moving the (physical or virtual) adjuster appropriately for changing the value corresponding to the smoothing degree. In any case, the user input device is adapted such that a single user control element maps the user input into a degree of smoothing that shall be achieved (smoothing degree).

The smoothing degree which has been set in step S3 is used in step S4 to adapt the determined changes in appearance of the second modality based on the smoothing degree and on boundaries present in the time-dependent characteristics of the first modality to arrive at resulting changes in the appearance of the second modality. This means, the determined changes are not simply adapted by overlying a specific frequency of changes or the like but the boundaries which are present in the time-dependent characteristics of the first modality are taken into account. How this is achieved according to the embodiment will be described in more detail below.

Further, an updated visual preview representation of the resulting changes in the appearance of the second modality is provided on the display 5. On the right side of FIG. 3b, an updated visual preview representation corresponding to an intermediate smoothing degree (corresponding to the position of the scroll bar on the left side in FIG. 3b) is shown with the resulting changes in the appearance of the second modality designated by 20′. FIG. 3c shows an updated visual preview representation corresponding to a maximum smoothing degree in which all changes in the appearance of the second modality are suppressed (i.e. the no color changes occur in the embodiment shown). Of course, many different intermediate smoothing degrees can be adjusted by means of the user input device 4. Since the visual preview representation is provided to the user, the user is conveniently provided with information about the structure of the changes in the appearance of the second modality which will occur. As a consequence, the changes become predictable for the user which is provided with immediate feedback. Thus, the user can conveniently adjust the desired smoothing (suppressing of changes in the appearance of the second modality) in correspondence with the resulting visual preview representation. As a result of step S4, resulting changes in the appearance of the second modality are provided.

In a further step S5, a control signal corresponding to the resulting changes in the appearance of the second modality is output for controlling the appearance of the second modality based on the first modality. In the example of music as a first modality and colored light as a second modality, this means that during music playback the color change of the colored light is controlled by the control signal.

Now, it will be described how the resulting changes in the appearance of the second modality are determined based on the smoothing degree and on boundaries present in the time-dependent characteristics of the first modality. Dependent on the adjusted smoothing degree, changes in the appearance of the second modality are deleted or restored as has been explained above. Deleting or restoring changes in the appearance of the second modality depending on the smoothing degree means that adjacent time periods of constant appearance which will also be called blocks of constant appearance (blocks of constant color in the case of the preferred embodiment) are merged or separated respectively. In this context, merging means that one block gets the same appearance as the adjacent block, while separating means that the block gets back the initially determined appearance (e.g. color of light in the preferred embodiment).

Mapping the smoothing degree to corresponding resulting changes in the appearance of the second modality can be performed in different ways. For example, the smoothing degree can be mapped to a (minimum) duration between subsequent modality changes. In this case, the determined changes in the appearance of the second modality (determined in step S2) are deleted and restored corresponding to the adjusted smoothing degree such that the resulting (minimum) time periods with no changes in the appearance of the second modality approximate this adjusted interval.

According to another example, the smoothing degree can be translated into a fixed number of changes which will be allowed in the appearance of the second modality (with a certain time interval or within a certain section of the first modality such as e.g. within a song). In this case, deletion and restoration of changes in the appearance of the second modality based on the smoothing degree is performed such that this fixed number of changes is achieved, independently from the length of the resulting time periods with no changes.

According to the embodiment, each (initially) determined change in the appearance of the second modality (as determined in step S2) is provided with a value (which will be called importance value in the following) reflecting at which smoothing degree the change is to be deleted or restored. These importance values are estimated in such a way that the user agrees with the deletion or restoration of changes in the modality, as will be explained below.

According to a first example, the importance value is determined based on the length of blocks in time between subsequent changes of the determined changes in the appearance of the second modality which have been determined in step S2. In this case, a block of constant appearance which is short in time is provided with a low importance value. This means that this block of constant appearance will be merged with a neighboring block of constant appearance at a relatively low smoothing degree already. In other words, the two changes in appearance of the second modality at the beginning of the block and at the end of the block are provided with a low importance value. In contrast, if a block is long, then the block will only be merged to a neighboring block of constant appearance when a high smoothing degree is adjusted. This means, the changes at the beginning and at the end of this block are provided with a higher importance value.

According to another example, the importance value is assigned to the determined changes in the appearance of the second modality based on the amount of changes in the corresponding time-dependent characteristics of the first modality. For the preferred embodiment in which music is the first modality this means that a high importance value is provided to changes in the appearance of the second modality which correspond to big changes in the music. Thus, these changes will only be deleted for a high smoothing degree. On the other hand, determined changes in the appearance of the second modality which correspond to small changes in the first modality (i.e. in the music in the preferred embodiment) are provided with low importance values. Thus, these changes in the appearance of the second modality will already be deleted at a lower smoothing degree.

Deletion and restoration of changes in the appearance of the second modality are performed in step S4 based on the smoothing degree and on the importance values. To this end, the importance values are analyzed. Deletion or restoration of changes is performed until the desired smoothing degree is achieved.

Thus, according to the embodiment, a device is provided which controls the changes of a second modality (e.g. colored light) that are triggered by a first modality. Changes in appearance of the second modality throughout time are automatically deleted or restored based on a degree of smoothing that a user can specify with a simple user input device. The smoothing degree corresponds to how many discrete changes within the appearance of the second modality will be present, wherein the initial amount of changes in the appearance of the second modality is automatically defined by the first modality. Due to the provision of a visual preview representation, the resulting changes are easily controllable and predictable. Mapping of the adjusted smoothing degree to resulting changes in the appearance of the second modality can preferably be performed by an algorithm performing the steps which have been described.

Although it has been described above that the method is realized by hardware, the method can also be realized by a computer program product which, when loaded into a suitable device such as a computer, performs the steps which have been described above.

Further, although in the preferred embodiment which has been described in detail the first modality is formed by music and the second modality is formed by colored light of different colors, the invention is not restricted to this. Another suitable example is, below others, changing between different dynamic light effects as a second modality to enrich the experience of a first modality. Further, for example movies can form the first modality and light signals the second modality, or light atmosphere can form the first modality and sound signals the second modality. Many other combinations are possible.

Although only combinations of a first modality and a second modality have been described throughout the specification, the invention is not limited to this and one or more further modalities can also be provided. The appearance of such further modalities can e.g. be controlled similar to that of the second modality.

1. Method for controlling a second modality based on a first modality, the method comprising the steps:
providing a first modality comprising time-dependent characteristics and a second modality capable of changing its appearance over time;
automatically determining changes in the appearance of the second modality based on the time-dependent characteristics of the first modality;
adjusting a smoothing degree by means of a user input device; and
adapting the determined changes in appearance of the second modality based on the smoothing degree and on boundaries present in the time-dependent characteristics of the first modality to arrive at resulting changes in the appearance of the second modality.

2. Method according to claim 1, wherein the first modality is any one of a sound signal, a video signal, and a light signal.

3. Method according to claim 1, wherein the second modality is any one of a light signal, a sound signal, and a video signal.

4. Method according to claim 1, wherein the first modality is a sound signal and the second modality is a light signal, in particular a light signal of variable color.

5. Method according to claim 1, wherein the second modality is formed by lighting effects.

6. Method according to claim 1, wherein the method further comprises the step of providing a visual preview representation of the resulting changes in appearance of the second modality.

7. Method according to claim 1, wherein discrete changes in the appearance of the second modality are deleted or restored dependent on the smoothing degree.

8. Method according to claim 1, wherein with increasing smoothing degree the number of resulting changes in appearance of the second modality is lowered.

9. Method according to claim 1, wherein, with increasing smoothing degree, shorter blocks in time in the determined changes in appearance of the second modality are increasingly replaced by adjacent blocks of appearance present in the determined changes in appearance of the second modality.

10. Method according to claim 1, wherein, with increasing smoothing degree, determined changes in the appearance of the second modality are increasingly deleted dependent on the amount of change present in the corresponding time-dependent characteristics of the first modality.

11. Method according to claim 1, wherein the automatically determined changes in the appearance of the second modality are assigned with a value reflecting at which smoothing degree the change is to be deleted and restored, respectively.

12. Method according to claim 1, wherein, with increasing smoothing degree, the minimum time interval between subsequent changes in the resulting changes in the appearance of the second modality is prolonged.

13. Device for controlling a second modality based on a first modality, the device comprising:
an output outputting a control signal for controlling the appearance of a second modality based on a first modality comprising time-dependent characteristics, the second modality being capable of changing its appearance over time; and
a user input device for inputting a smoothing degree by a single adjuster;
wherein the device is configured such that:
changes in the appearance of the second modality are automatically determined based on the time-dependent characteristics of the first modality, and
the automatically determined changes in the appearance of the second modality are adapted based on the smoothing degree and on boundaries present in the time-dependent characteristics of the first modality such that a signal corresponding to resulting changes in appearance of the second modality is output.

14. Device according to claim 13, comprising a visual user interface and adapted such that a visual preview representation of the resulting changes in appearance of the second modality is provided on the visual user interface.

15. A computer-readable media containing a set of instructions, which, when executed a computer, cause the computer to perform the following steps:
analyzing data corresponding to a first modality comprising time-dependent characteristics,
outputting data corresponding to a control signal for a second modality capable of changing its appearance over time;
automatically determining changes in appearance of the second modality based on the time-dependent characteristics of the first modality;
adjusting a smoothing degree based on a user input via a single adjuster; and
adapting the determined changes in appearance of the second modality based on the smoothing degree and on boundaries present in the time-dependent characteristics of the first modality to arrive at resulting changes in the appearance of the second modality.
